(19) United States
(12) Patent Application Publication
(10) Pub. No.: US 2011/0167624 A1
(43) Pub. Date: Jul. 14, 2011

(54) METHOD FOR MANUFACTURING COIL HOLDERS

(76) Inventor: Jen-Yao HU, Tainan County (TW)

(21) Appl. No.: 12/685,212

(22) Filed: Jan. 11, 2010

(51) Int. Cl. H01F 41/00

(52) U.S. Cl. 29/605

(57) ABSTRACT

A method for manufacturing coil holders aims to improve the disadvantages of complicated fabrication processes and undesirable production efficiency of the conventional techniques. The method includes: providing a bobbin and a conducting wire and winding the conducting wire on the bobbin, encasing the bobbin wound with the conducting wire with a molding material and reserving a through hole in the molding material corresponding to the bobbin to form a coil rack, and inserting a magnetic core into the through hole to hold on the coil rack to become a finished product of a coil holder. The present invention can finish fabrication of the coil holder through only one injection molding process. It greatly simplifies fabrication process and can reduce cost and increase production yield.

### FIELD OF THE INVENTION

The present invention relates to a method for manufacturing coil holders and particularly to a method for manufacturing coil holders used in electronic products.

### BACKGROUND OF THE INVENTION

Advance of technology and well development of all types of electric appliances and products have spawned a wide variety of basic elements to meet different design requirements. Coil is one of the most complicated and versatile elements.

Elements containing coils are commonly used on transformers, choking coils and the like in electric appliances and products. A conventional transformer or choking coil usually has a winding rack which the coils are wound and held thereon, then an iron core or silicone steel sheets of varying profiles and sizes can be installed according to different requirements, finally is encased by an insulation layer. The insulation layer generally is made from plastics or insulation tape. Some even is covered by a metal housing. This is the most commonly seen basic structure of the coil element. References can be found in R.O.C. patent Nos. M335091, M320159, and 452155 for techniques to simplify production and assembly process; 1,254,330, 1,239,537 and 560683 providing techniques adaptable to meet various coupling specifications and requirements, and techniques to enhance structure can be found in 1,232,470, M253046 and 1,224,797. Numerous references related above techniques also are available in prior arts.

While a lot of progresses have been made on the techniques to improve the stricture of coil elements, their fabrication involves some common processes, such as first, winding a conducting wire on a coil rack, and coupling the iron core or silicone steel sheets, and finally encasing with the insulation layer. These processes become almost the standard and are taken for granted. Each process step has its share of risk, such as a complex coil rack structure could make winding difficult, a gap is formed between the coil rack and iron core or silicone steel sheets that often incurs vibration and results in noise generation, not fully encased by the insulation layer could result in electric leakage. Moreover, production and assembly involve a great deal of time and human labor, and result in a higher cost and lower production yield. All these show that there are still rooms for improvement.

### SUMMARY OF THE INVENTION

The primary object of the present invention is to solve the aforesaid disadvantages by providing a simplified method and process to fabricate coil elements.

To achieve the foregoing object, the present invention provides a method for manufacturing coil holders. The method comprises:

a winding step: providing a bobbin and a conducting wire and winding the conducting wire on the bobbin;

a molding step: encasing the bobbin wound with the conducting wire with a molding material and reserving a through hole on the bobbin to form a coil rack; and

an assembly step: inserting a magnetic core into the through hole to be held on the coil rack to form a finished product of a coil holder.

In an embodiment of the present invention, the molding step includes disposing the bobbin wound with the conducting wire in a molding mold and inserting a molding rod into the bobbin, then injecting the molding material to form the coil rack with the through hole in an integrated manner. The molding step includes a material injection step in which the bobbin wound with the conducting wire is disposed in a molding mold and injecting the molding material into the molding mold to form the coil rack in an integrated manner. The molding step further includes a coupling step in which the distal end of the conducting wire is fastened to a pin. The coupling step can be executed before the material injection step by soldering the pin on the distal end of the conducting wire by solder, then disposing them into the molding mold so that after the material injection step the distal end of the conducting wire is encased in the molding material. The coupling step may also be executed after the material injection step with the distal end of the conducting wire exposed outside the molding material, and solder the distal end of the conducting wire on the pin after the material injection step is finished.

Compared with the conventional techniques, the present invention provides many benefits, notably:

1. While making the conventional coil elements requires a complicated process and involves assembly of a coil rack, coil holder, insulation layer and the like, the present invention can finish fabrication of the coil elements through only one injection molding process. It greatly simplifies fabrication process and can reduce cost and increase production yield.

2. The present invention forms insulation through integrated injection molding process during forming the coil holder, and can fully encase the conducting wire to form secure insulation to enhance the reliability and safety of the elements.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of a first embodiment of the present invention.

FIG. 2 is a block diagram of a second embodiment of the present invention.

FIG. 3 is block diagram of a third embodiment of the present invention.

FIGS. 4A through 4E are schematic views of processes according to the second embodiment of the present invention.

FIGS. 5A through 5D are schematic views of processes according to the third embodiment of the present invention.

### DETAILED DESCRIPTION OF THE PREFERRED EMBODIMENTS

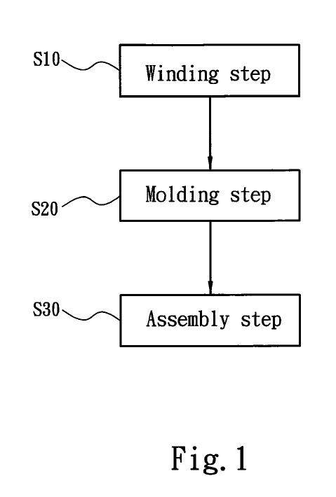

The present invention aims to provide a method for manufacturing coil holders. Please refer to FIG. 1 for the block diagram of an embodiment of the present invention. The method mainly comprises the steps as follow:

a winding step S10: provide a bobbin and a conducting wire and wind the conducting wire on the bobbin;

a molding step S20: encase the bobbin wound with the conducting wire with a molding material and reserve a through hole on the bobbin to form a coil rack; and

an assembly step S30: insert a magnetic core into the through hole to be held on the coil rack to form a finished product of a coil holder.

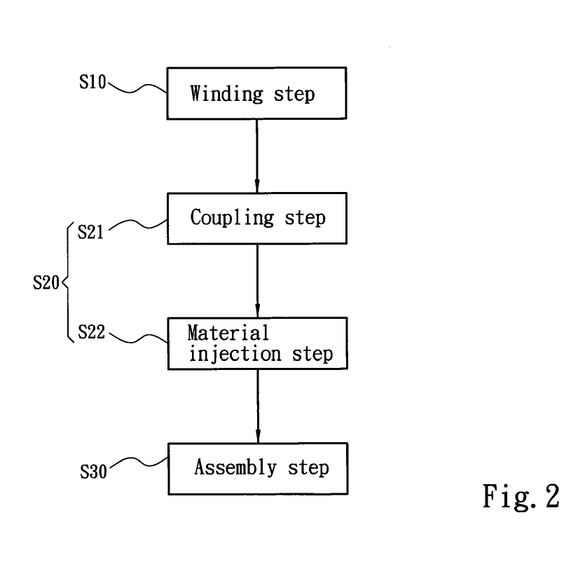

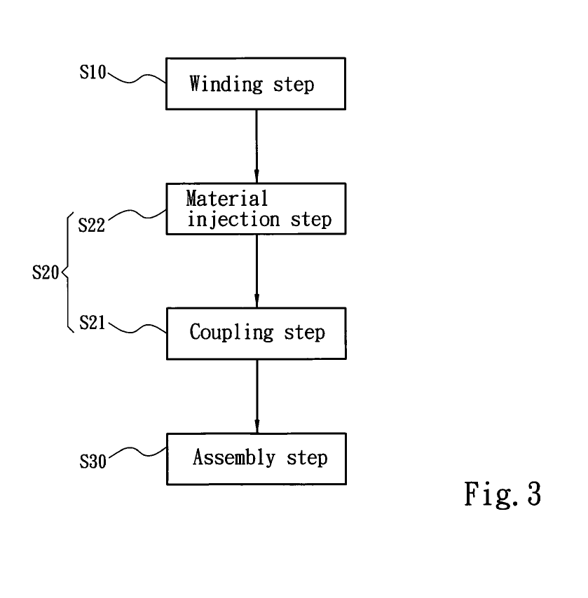

Refer to FIG. 2 for the block diagram of another embodiment of the present invention. In this embodiment, the molding step S20 includes a coupling step S21 and a material injection step S22. At the material injection step S22, the bobbin wound with the conducting wire is disposed in a molding mold, then injects the molding material into the molding mold to form the coil rack in an integrated manner. The coupling step S21 may be proceeded before the material injection step S22 by soldering a plurality of pins to a distal end of the conducting wire, then they are disposed in the molding mold with the conducting wire and the bobbin so that the pins are formed on the coil rack with the conducting wire and bobbin at the material injection step S22, and the distal end of the conducting wire is encased in the molding material. FIG. 3 illustrates the process of yet another embodiment in which the coupling step S21 is proceeded after the material injection step S22. During the material injection step S22, the distal end of the conducting wire is exposed outside the molding material. After the material injection step S22 is finished, the distal end of the conducting wire is soldered on the pins outside the molding material.

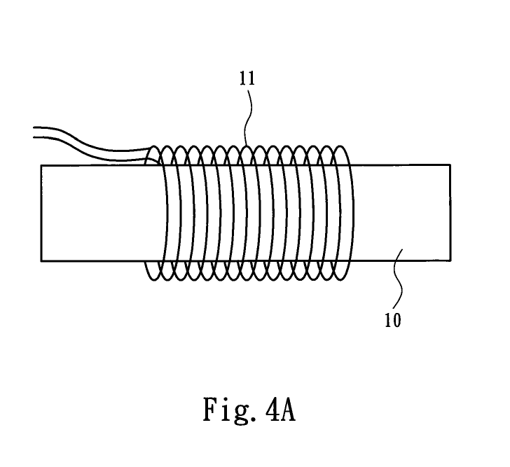

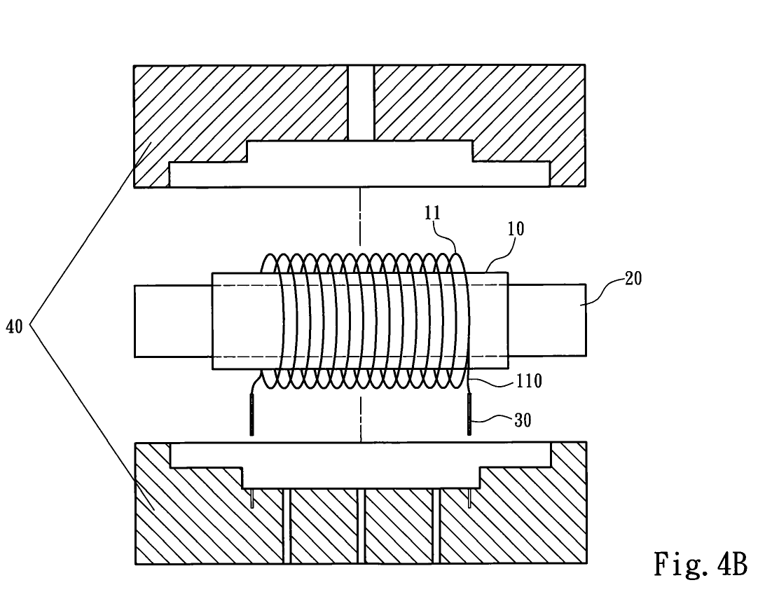

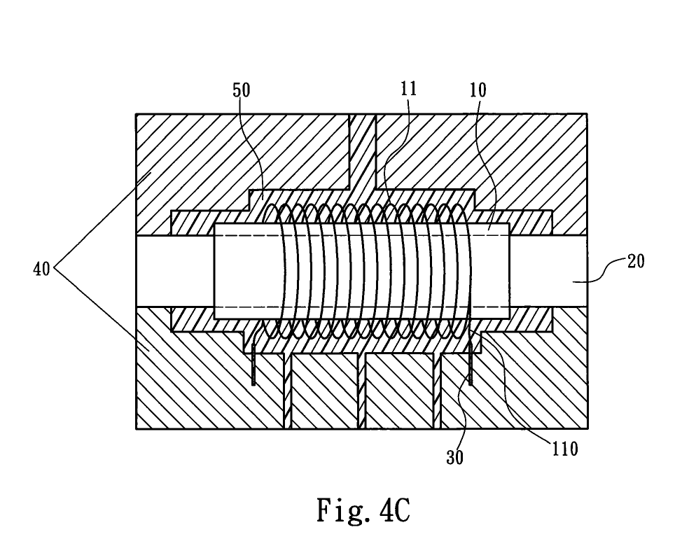

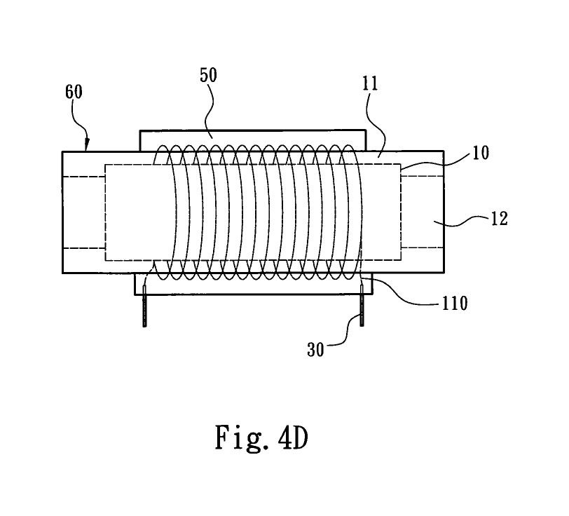

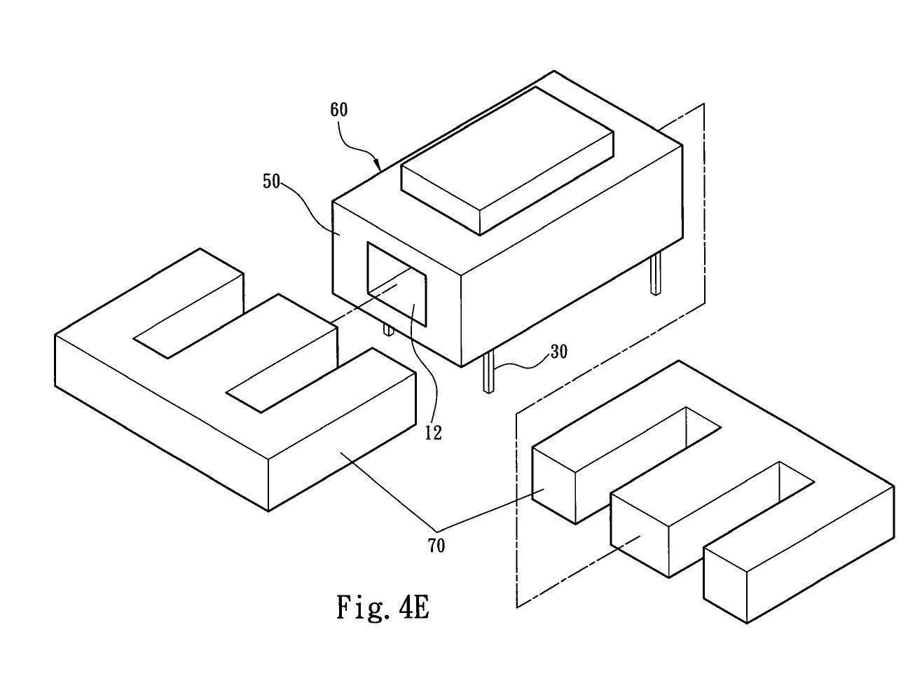

Refer to FIGS. 4A through 4E for the processes according to the second embodiment shown in FIG. 2. During fabrication of the present invention, first proceed the winding step S10 by providing a conducting wire 11 and a bobbin 10, and winding the conducting wire 11 on the bobbin 10; next, proceed the coupling step S21 and material injection step S22 of the molding step S20, and fasten pins 30 to the distal end 110 of the conducting wire 11 by soldering; dispose the bobbin 10 with the conducting wire 11 wound thereon and the pins 30 in a molding mold 40 at a desired location, insert a molding rod 20 into the bobbin 10, and inject an insulated molding material 50 into the molding mold 40 to encase the conducting wire 11 and the bobbin 10 to form a coil rack 60 that has a through hole 12, and the distal end 110 and pins 30 are connected in the forming material 50 in an integrated manner.

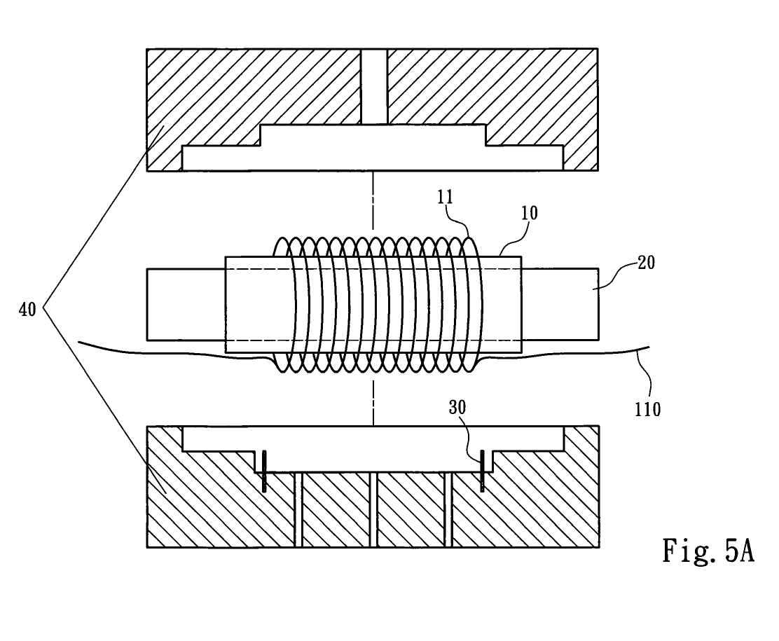

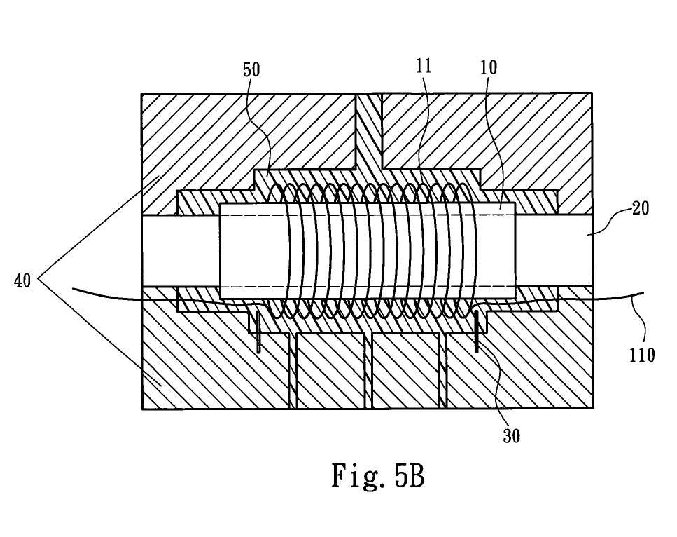

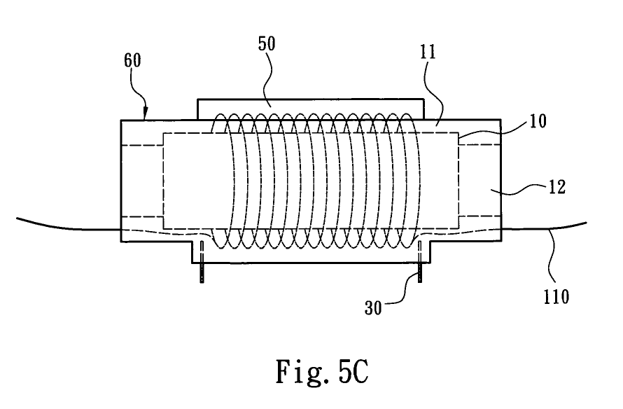

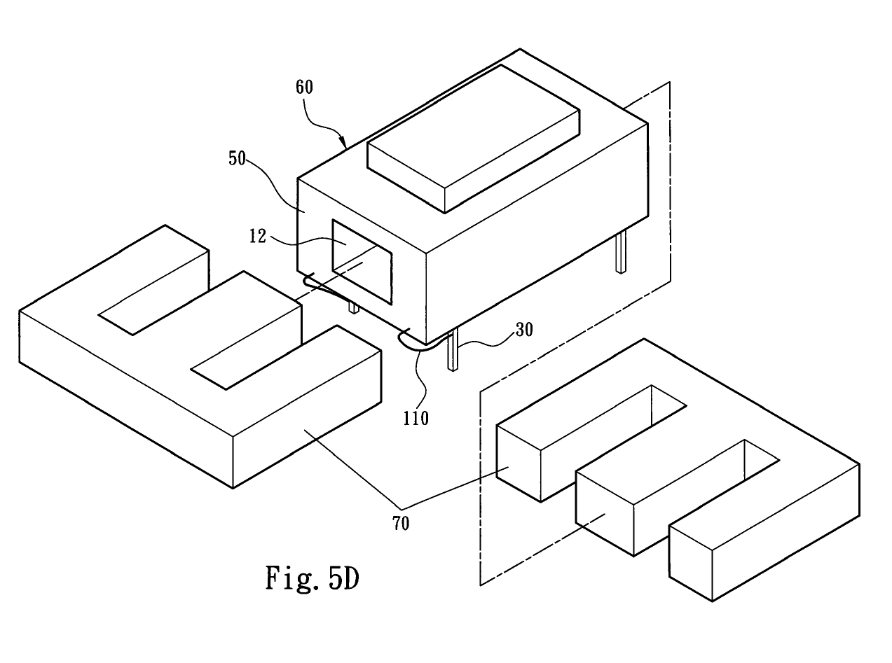

To meet different requirements of mating varying electric connecting locations of different electronic devices, the process sequence of the molding step S20 may also be changed as depicted in the third embodiment shown in FIGS. 5A through 5D incorporating with FIG. 3. In this embodiment, the material injection step S22 is proceeded before the coupling step S21 at the molding step S20. First, dispose the conducting wire 11, bobbin 10 and pins 30 in the mold 40; inject the molding material 50 with the distal end 110 exposed outside the molding material 50 so that the formed coil rack 60 has varying electric connecting locations to suit different electronic devices; then solder the distal end 110 outside the molding material 50 to desired pin 30 to meet electric connection requirement of the electronic devices; finally, proceed the assembly step 30 by inserting a magnetic core 70 into the through hole 12 to be held on the coil rack 60 to form a finished product of the coil holder.

As a conclusion, the method provided by the present invention mainly includes first, winding the conducting wire 11 on the bobbin 10 and encasing the conducting wire 11 and bobbin 10 with the molding material 50 to form the coil rack 60; then assembling the magnetic core 70 on the coil rack 60 to form the finished product of the coil holder. Hence fabrication of the coil elements can be finished through merely one injection molding process. Compared with the conventional techniques, the present invention provides many benefits, notably:

1. While making the conventional coil elements requires a complicated process and involves assembly of a coil rack, coil holder, insulation layer and the like, the present invention can finish fabrication of coil elements through only one injection molding process. It greatly simplifies fabrication process and can reduce cost and increase production yield.

2. The present invention forms insulation through the integrated injection molding process during forming the coil holder, and can fully encase the conducting wire 11 to form secure insulation to enhance the reliability and safety of the elements. While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A method for manufacturing coil holders, comprising:
a winding step: providing a bobbin and a conducting wire and winding the conducting wire on the bobbin;
a molding step: encasing the bobbin wound with the conducting wire with a molding material and reserving a through hole on the bobbin to form a coil rack; and
an assembly step: inserting a magnetic core into the through hole to hold on the coil rack to form a finished product of a coil holder.

2. The method of claim 1, wherein the molding step includes a material injection step by disposing the bobbin wound with the conducting wire in a molding mold and injecting the molding material into the molding mold.

3. The method of claim 2, wherein the molding step further includes a coupling step to fasten a distal end of the conducting wire to a pin.

4. The method of claim 3, wherein the coupling step is proceeded before the material injection step to encase the distal end of the conducting wire in the molding material.

5. The method of claim 3, wherein the coupling step is proceeded after the material injection step to expose the distal end of the conducting wire outside the molding material.

6. The method of claim 3, wherein the coupling step includes soldering the distal end of the conducting wire to the pin through a solder.

7. The method of claim 1, wherein the molding material is an insulation material.

8. The method of claim 1, wherein the molding step further includes inserting a molding rod into the bobbin to form the through hole.
